(19) United States
(12) Patent Application Publication
(10) Pub. No.: US 2019/0197789 A1
(43) Pub. Date: Jun. 27, 2019

(54) Systems & Methods for Variant Payloads in Augmented Reality Displays

(71) Applicants: Robert M. MACAULEY, Venice, CA (US); Timothy S. MARTIN, El Dorado Hills, CA (US); Guy Craig VACHON, Aptos, CA (US); Patrick A. COSGROVE, Honeyoye Falls, NY (US)

(72) Inventors: Robert M. MACAULEY, Venice, CA (US); Timothy S. MARTIN, El Dorado Hills, CA (US); Guy Craig VACHON, Aptos, CA (US); Patrick A. COSGROVE, Honeyoye Falls, NY (US)

(73) Assignee: Lifeprint LLC, El Dorado Hills, CA (US)

(21) Appl. No.: 16/231,473

(22) Filed: Dec. 22, 2018

Related U.S. Application Data
(60) Provisional application No. 62/610,182, filed on Dec. 23, 2017.

(51) Int. Cl. G06T 19/00; G06K 9/32; G06Q 30/02; H04N 21/81; H04N 21/2187

(52) U.S. Cl. CPC G06T 19/006; G06K 9/3241; G06Q 30/0261; G06Q 30/0277; H04N 21/812; H04N 21/2187; G06Q 30/0252

(57) ABSTRACT

Augmented-reality systems provide additional information to users, beyond what they can normally perceive with their own senses. Embodiments of the invention establish “cover objects” having an identifiable visual appearance, and provide systems and infrastructure to deliver the additional information to multiple users via a live digital-camera image when each user directs his or her camera at the cover object. Different users may receive different additional information when scanning the same cover object at the same time, and a single user may receive different additional information when scanning the same cover object at different times. Methods and systems for accomplishing this are described, and a number of applications using the capabilities of such systems are suggested.

### CONTINUITY AND CLAIM OF PRIORITY

This is an original U.S. patent application which claims priority to U.S. provisional patent application No. 62/610,182 filed 23 Dec. 2017. The entire disclosure of the provisional application is incorporated by reference, and also by inclusion within the present Specification.

### FIELD

The invention relates to augmented reality. More specifically, the invention relates to systems and methods for delivering different augmented-reality information or assets to different users who access the AR information by imaging a common key or “cover” object at about the same time.

### BACKGROUND

Augmented reality systems often provide additional information to their users, to help them perceive conditions that are not apparent to ordinary human senses, to highlight things deserving of special attention, or simply to provide additional information conveniently. The additional information is often presented visually, either by projecting it into the user's field of vision on a heads-up display, or by altering a graphical video image to incorporate the additional information.

Hardware and software systems and methods for implementing augmented reality (“AR”) systems are relatively well known. Innovations in display technology can improve the precision and resolution with which augmenting information is presented to the user, and innovations in computer image-processing can help systems determine what information may be most useful to provide to the user. A common operational paradigm, described in a 2015 French patent application by Clément Perrot (PCT/FR2015/051120), involves scanning a scene using a digital camera. An object in the scene which is visible in the digital image, is detected by an image recognizer, and the portion of the image depicting the object is altered or replaced on the camera's display. For example, if the camera is imaging a scene that includes a poster, then a video clip may be composited into the live camera display where the poster would appear. The poster may thus appear to “come to life.”

Other applications may be built on similar foundations. For example, a camera view of a street may be augmented with the names or addresses of buildings visible on the street, and a camera view of a sign in one language may be altered to present the text of the sign in a different language.

Components of the infrastructure to accomplish the foregoing examples are undergoing rapid development, so the end-user performance of AR systems is improving. In view of this improvement, new methods of selecting and delivering AR content may also yield significant value in this area.

### SUMMARY

Embodiments of the invention prepare multiple different augmented-reality (“AR”) assets and associate them with a single trigger (or “cover”) object. Then, when a user images a scene containing the cover object, auxiliary data about (or associated with) the user and the scanning conditions are consulted to select one of the multiple AR assets. The selected AR asset is delivered to the user, and his imaging device (e.g., a digital camera with a live display) composites the asset into the display, either altering or completely replacing the image of the cover object with the AR asset. Two different users, imaging the same cover object at the same time, may receive different AR assets. Or the same user, imaging the same cover object at two different times, may receive different AR assets. Other applications and operational details are described and claimed herein.

### BRIEF DESCRIPTION OF DRAWINGS

FIG. 1 shows a sample environment where an embodiment of the invention can be implemented.

FIG. 2 is a flow chart outlining operations of an embodiment of the invention.

FIG. 3 shows another depiction of the participants and infrastructure that work together in an embodiment.

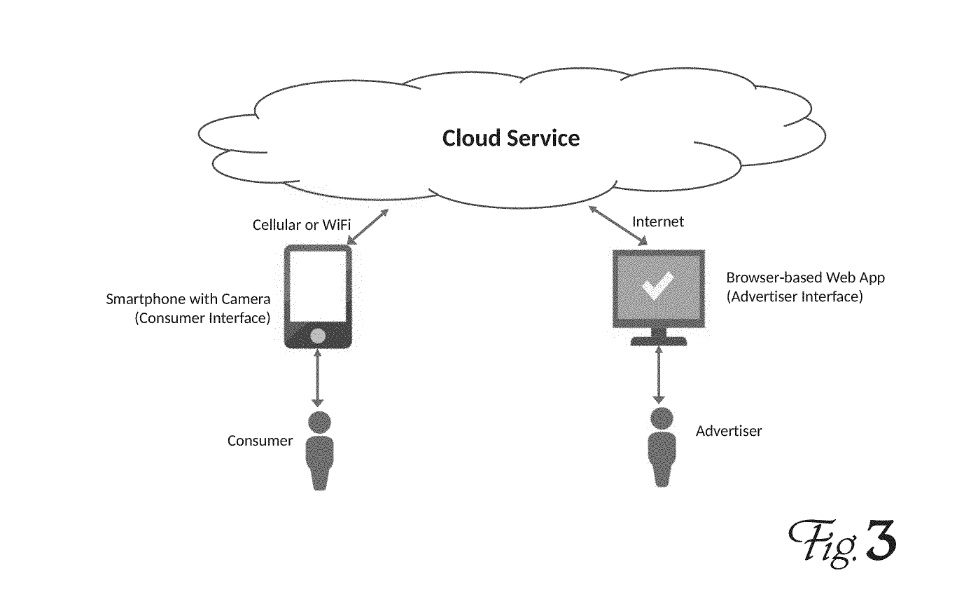

FIG. 4 illustrates one way of distributing data and computing responsibilities in an embodiment of the invention.

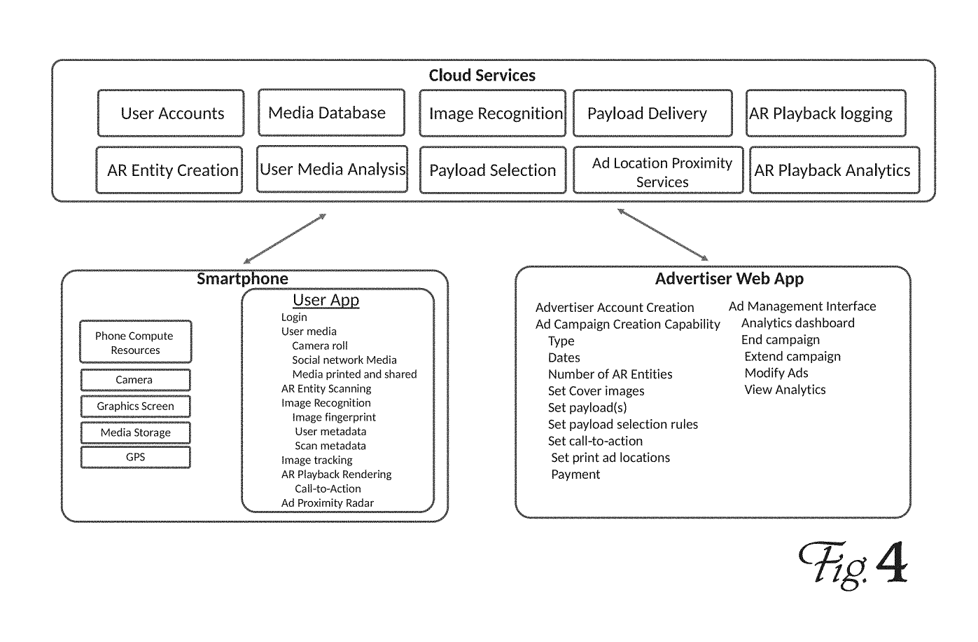

### DETAILED DESCRIPTION

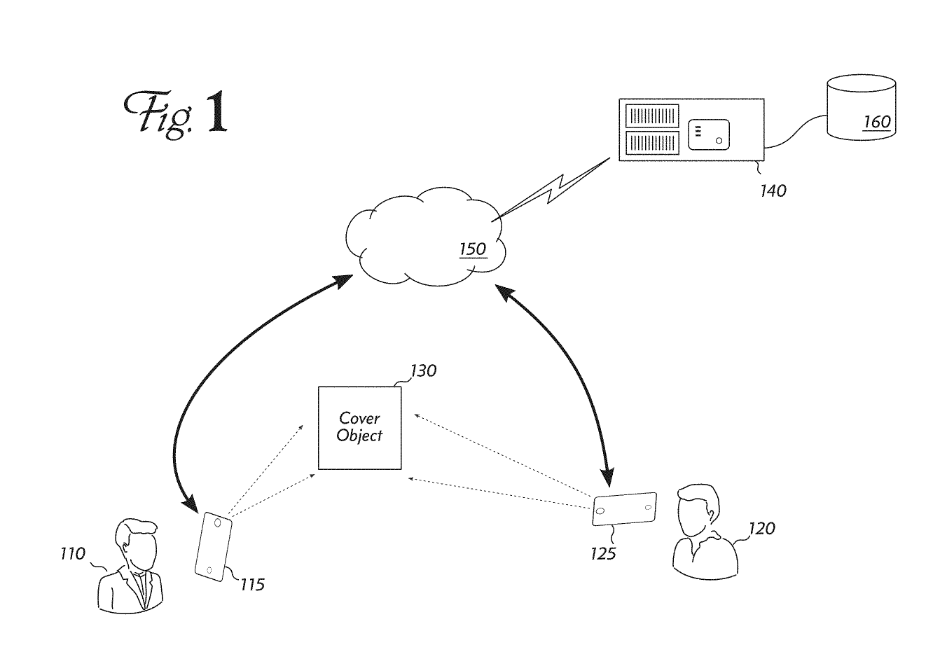

FIG. 1 shows some of the devices that are involved in the operation of an embodiment of the invention, and some of the communications between them that support such operation. It is appreciated that computing resources and data storage can be moved around quite freely in a distributed data communication network, so the exact arrangement of devices and communication messages shown here is not the only way an embodiment could be implemented.

The system components cooperate to deliver augmented-reality (“AR”) assets to end users 110 and 120. The assets may be delivered to devices such as cell phones 115 and 125. The important characteristics of the end-user delivery devices 115 and 125 are that they include digital imaging (camera) functionality, and graphic display functionality. Most cell phones have suitable imaging and display capabilities, as well as data-communication facilities that are helpful to the operation of an embodiment.

Users 110 and 120, using their devices 115 and 125, image a scene containing the same “cover object” 130. The users may be physically positioned differently with respect to the cover object, so each user's camera views a different scene, and the cover object may appear in a different orientation or a different size on each user's live display of the camera view.

Each device transmits some or all of its camera view as an image to a central server 140. The devices may intermittently transmit frames (e.g., once every few seconds) or continuously, depending on the capabilities of the data communication links and the other needs of the system. Transmission can take place over a distributed data network 150 such as the Internet.¹ ¹ This description includes a conceptual simplification for ease of comprehension. Implementers of systems such as these will recognize that it is often unnecessary to send the full camera image for automatic image recognition purposes. Instead, the camera may prepare a smaller “fingerprint” of the image—a sort of hash code based on a numerical treatment of certain key features detected in the image. The fingerprint, which is much smaller than the full image, can be sent efficiently and “recognized” quickly by the server based on a comparison with stored fingerprints of cover objects and scenes containing cover objects. In a system that actually sends a full graphical image, it is preferable to send a reduced-resolution image, and/or one with color information removed, to reduce the amount of data that must be transmitted.

The central server 140 receives the images and attempts to identify the cover object in each. Identification may be performed using known automatic image recognition technology. Recognition performance may be assisted by extra-image information, such as the GPS location of the phone, its magnetic heading, time of day, or by location markers (e.g., QR codes visible to the camera and embedded in the image). Although the images from users 110 and 120 in this example show the same cover object, it should be appreciated that central server 140 may be receiving images from thousands of other devices as well. These other images may show completely different cover objects. The central server may treat all such image streams similarly.

In the scenario depicted here, central server 140 will detect the cover object 130 within the images transmitted from both users' devices, and look up the cover object in pre-populated database 160. This database includes a plurality of different AR assets associated with the same cover object. The assets may be similar in kind, but different in content. For example, there may be two different video clips. The assets may also differ in kind—there may be one video clip, and one audio clip. In some implementations, one or more of the different AR assets may be generated on the fly. For example, an AR asset may comprise a count of the number of users who are currently interacting with the same cover object.

The central server 140 selects from among the plurality of different AR assets on the basis of an auxiliary datum transmitted from each user with the image(s) of the scene including the cover object 130. For example, each user's device may transmit an identification of the user, or information about a characteristic of the user—the user's gender or age, for instance. In a preferred embodiment, the central server will have AR assets that are entirely specific to a particular user—these will only ever be selected when that user interacts with the particular cover object.

Once the central server 140 has selected one of the plurality of different AR assets associated with the cover object 130 and the user (110 or 120), it sends the AR asset back to the user's device, perhaps using the same distributed data communication channel. The user's device (115 or 125) may update its display by compositing (altering or replacing) the portion of the display showing the cover object with the AR asset.

The upshot of this method is that, for example, the users 110 and 120 may both direct their camera-devices at a cover object 130 such as a poster, billboard or building, and each will receive a different AR asset that will appear on their respective device screens.

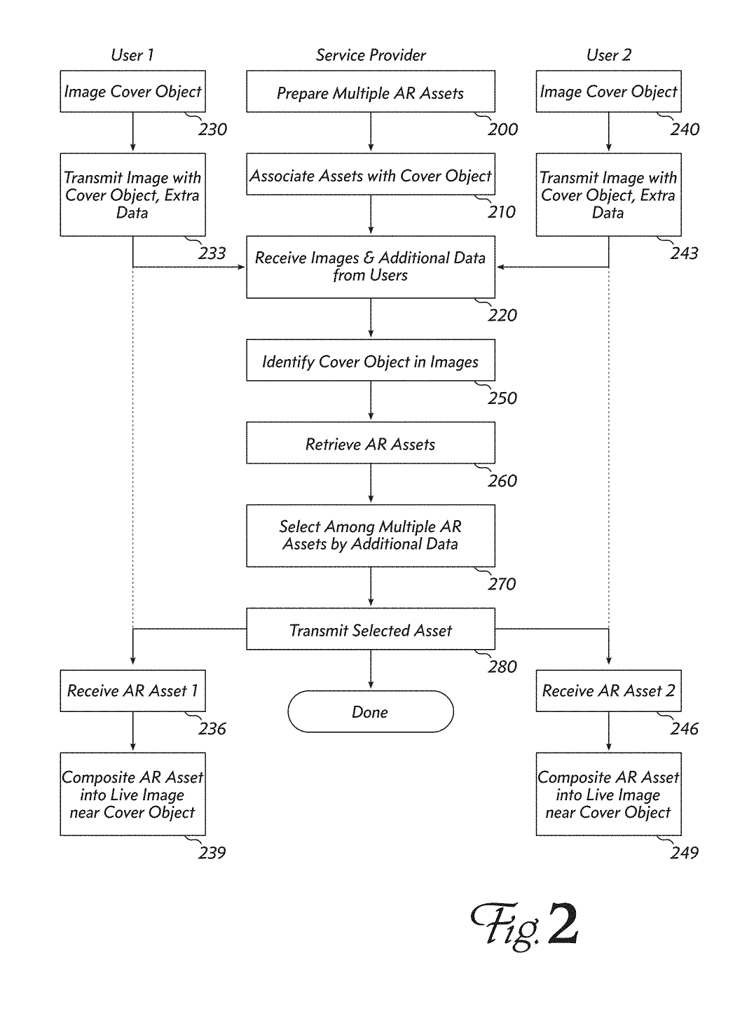

FIG. 2 is a flow chart outlining operations of a representative embodiment of the invention. A central service provider (similar to central server 140 in FIG. 1) prepares multiple augmented-reality assets (200). These are associated with a single cover object (210). (Other pluralities of assets may be associated with other cover objects.) Next, the service provider arranges to receive images and additional data from users (220).

A first user employs his imaging device (e.g., a digital camera of a cellular phone) to image the cover object (230). This image (including the cover object, as well as some additional data associated with the user) is transmitted to the service provider 233. At around the same time, a second user may also image the cover object (240), and transmit the image with some information about the second user to the service provider (243)

The service provider receives these images and data (220), identifies the cover object in the images (250), and retrieves the plurality of AR assets associated with that cover image (260). Then, it chooses among the plurality of AR assets on the basis of the additional data transmitted by each user (270), and transmits the selected AR asset to each individual user (280).

Back at the users' devices, the AR assets are received (236, 246) and composited into a live display of each corresponding device, near or over the cover object shown on the displays (239, 249).

It is appreciated that the users may not hold their camera devices perfectly still while the AR assets are being composited into the live display. Software on the camera may recalculate the position of the cover object on the display, and adjust the size, shape or aspect ratio of the AR asset so that it remains at or near the location of the cover object on the display. This helps to stabilize the display of the AR asset and improve its usefulness to the user.

### Regarding Cover Objects

A “cover object” as used herein means an object or image that can be perceived by a digital camera—essentially, something that a digital camera can take a picture of—and that can be recognized by an automatic image recognition system. Note that the cover object does not have to be directly perceptible to a human. A cover object may be, for example, a design or pattern printed in infrared or ultraviolet ink, which can only be imaged by a digital camera under specialized illumination. A cover object does not have to be a physical object. It may be, for example, a pattern or design projected onto a surface using visible or invisible (infrared, ultraviolet) light (provided, again, that the digital camera can detect the design and take a picture of it). Of course, a physical object that is directly perceptible to a user can also be a cover object. A cover object may be a poster, a billboard, or a famous (or mundane) landmark. A cover object may be a photograph or a printed design in a magazine. A cover object may be of a class of objects. For example, a particular model of car may serve as a cover object. In this case, the system might choose to send an AR asset including an advertisement for the car from among a plurality of such advertisements. One interesting category of cover objects is a person—a digital camera can obtain an image of a person, and automatic image recognition systems can often identify particular people, so a person can serve as a cover object. When a user of the system images a scene where the “cover object” person is present, the user may receive a personalized AR asset involving both the user and the cover-object person. And, according to other characteristics of embodiments of the invention, a second user imaging the same cover-object person at the same time, would receive a different AR asset, possibly involving the second user and the cover-object person.

### Regarding Augmented-Reality Asset Selection

Each cover object in an embodiment may be associated with a plurality of different AR assets or “payloads.” A distinguishing characteristic of an embodiment is that two different users, viewing the same cover object at about the same time, will receive different AR assets. In addition, the same user, viewing the same cover object at two different times, may receive different AR assets. The ability to deliver different payloads based on user and time (among other differentiating factors), means that the system can support a variety of useful operational modes.

A system may choose among the plurality of AR assets associated with a particular cover object by constructing an identifier that is correlated to one or more characteristics of the user of the system (i.e., the person operating the digital camera). This identifier may be specific to a single individual, to a group of people that the individual belongs to, to a place or time, or to a combination of such factors. This identifier can be used to choose an asset that is suitable to send to the user.

Suppose a cover object is placed in an entertainment theme park. AR assets may be created that show experiences that each user has engaged in at the park—for example, one user may have been photographed while riding a roller coaster, and another user may have been photographed meeting a fictional “mascot” character. When these users scan the same cover object, one may be shown the roller-coaster photo, while the other may be shown the “mascot” meeting. Further, if these users scan the same cover object later in the day, they may be shown video of themselves, captured while enjoying other attractions.

The inventive system may be adaptive, in that it maintains a record of AR assets that have previously been delivered to a user in connection with a particular cover object, or in connection with a particular series of AR assets. This information may be thought of as a playback indicator along an extended AR asset. Thus, the first time a user scans a particular cover object, he may receive the beginning of lengthy AR video. Suppose the user watches 30 seconds of the video, then stops imaging the cover object with his digital camera. Later, when the user images the cover object again, the succeeding portion of the video may be delivered, based on the identification of the user and the system's knowledge that the first 30 seconds have already been displayed.

### Long Duration Payload AR Experience.

Since AR reality experiences are constructed in real-time as the user views the camera feed from his smartphone, these experiences tend to be designed to have a relatively short duration. Typically these experiences are designed to last anywhere from 5 seconds to 30 seconds. Longer AR experiences can become tedious or uncomfortable for the user. However, in some cases it may be desirable to create a richer extended AR experience for the user. This can be done by taking a longer AR experience and segmenting it into a series of smaller segments or “Chapters” than could be presented in a serialized fashion to the user. When a user scans the Cover image or object, the first portion of the segmented AR Experience plays. Subsequent scans of the cover image or object would play each of the “chapters” in the sequence until the entire experience has been delivered to the user. These extended AR experiences can take one of two major forms:

Single Cover Image/Object. In this case, a common cover image is used as the trigger for the experience. The system would be designed so that it knows what payload segments have been seen already by seen by specific users. This allows the system to determine what payload segment should be played on each scan of the cover. For system where users are required to have an account for user or access, this can be easily done by including a user identity code as part of the scanning information sent to the Cloud during the scan process. In those system that do not require user accounts, unique user identifiers or cookies can be created by the app using various method well known in the art. It should be noted that such identifiers are extremely useful in providing rich analytics about the population of users triggering the AR Experience.

Different Cover Image/Object. In this case, each AR Experience segment is triggered by a different Cover Image/Object. This would allow the user to progress in the AR experience by scanning a first and then subsequent Cover Images/Objects. The advantage of this approach is that the system does not have to track which segments of an AR experience a user has seen and what segments remain to be seen—this is controlled by the user. One could image a book where each page, when scanned, would trigger progressive AR Payloads as each page is scanned. This would allow the user to control the pace of the AR experience delivery, enhance the value of the original printed “book” by providing a rich augmented experience. It can be readably seen, that the book used in this example could be readily replaced with a magazine, a newspaper, a flyer, a poster with several cover images, or even a gallery display of cover images or objects. In other case, one could imagine a Scavenger Hunt, where participants where told where to find the next Cover Image/Object that would unveil the next payload segment.

### Personalized Payloads for Given Cover Image/Object.

In many use cases explored thus far, the various AR Payloads are created by the designer of the experience and associated with the cover image/object. Upon scanning, scan time and user metadata is used by a rule-based system to select the appropriate payload that will be delivered. Used in this way, the payloads are pre-designed and the system selects the payload best suited for the viewer based on AR-designer created rules. However, there is another approach that could be considered that will leverage payloads that are highly personalized for a given user. In this case, the payload might involve images or videos of the user themselves. Thus, the generated AR experience would highlight the user themselves creating an experience that would be very personal and thus highly valued. This could leverage the Variant AR Payload capability of the proposed system to create high value products for the user. For example, imagine a service at a theme park where a cover image of the Parks Logo or key park attraction when, when scanned, would show a video of the user having fun at the park. Each user that scanned the same Cover Image/Object, would get a different and highly personalized experience. In this example, the payload is entirely unique to each user. However, one could also imagine the case where a standard AR experience was customized in part, to adapt it for each user. For example, a standard payload could consist of a well-known sequence from a major motion picture. However, the face of the main actor has been switched with an image of the user's face to create a something often referred to as a “deep fake.” The resulting AR experience would show the user in famous movie scenes. Such methods of leveraging Variant AR Experiences would allow for the creation of unique user-customized products. The key challenges for these use cases is to capture or create personalized payloads and to then associate them with the user during scan time.

### Capturing Personalized Content.

There are three basic methods of securing personal content:

User supplied. In this case, the user captures and creates the payload using their own media and devices and submits this content to the system so that the AR Experience can be created and associated with a cover image/object. The system has to provide a method to acquire and pre-process this payload for use by the system. This can best be done by the combination of a device, app and cloud service solution.

Third Party Capture. In this case the key media used to create the payload is captured and processed by an entity other than the user. In the theme park example already described, this could be staff member of the park whose job was to capture video of users in the park for use as payloads for the custom creation of AR products. They would use a camera device to capture and process the content and upload the newly created payload to the system that created the Variant Payload AR Experience. Critical to this, is the ability identify the user that this payload is targeted for.

Hybrid Generation. In this case, the user provides some media and the Variant Payload AR Experience system also provides some media. In the latter case, this often would take the form of a template designed to be combined with the user provided media. Then either a manual, automated, or semi-automated system is used to combine the two sets of media to create a single customized payload. Again, it is critical that this payload be associated with the user that this payload has been customized for.

Scan Time Payload Selection. With personalized case, it is necessary that user identification information be submitted during the scan process. The resulting AR Experience will consist of a common cover image/object and potentially a large number of associated customized payloads. The user information shared as part of the scanning process allows the system to select the appropriate payload that should then be delivered to that user during the scan and playback process. It should again be noted that such identifiers are extremely useful in providing rich analytics about the population of users triggering the AR Experience.
1. Augmented Reality Photo-Video Experiences
   7.7. Summary of the Invention. With the advent of Augmented Reality Technology, Smartphone user experiences are becoming richer by augmenting real-time views of the user's world—as seen by the Smartphone camera—with synthesized graphics and imagery that are integrated into the camera stream in real-time. The result is a mix of reality and graphical/pictorial augmentation that can create a vast array of user experiences. One way that this technology is being used to take media that is traditionally static in nature, such a print ad, and changing it to one that is dynamic. In fact, it can appear to the user to “come to life”. For example, a print ad can take the form of an image with some text. But once viewed with an Augmented Reality Viewer app on your smartphone, the print turns into a video playback that appears on the phone display where the printed ad image was seen in the original camera field of view. Thus, the static print ad can turn into a video experience with sights and sounds that have much greater ability to deliver a rich message to the user. This is a relatively new area of practice that will grow as the technology evolves. While it requires a sophisticated system to deliver this experience to the user, there is a growing list of commercial providers of this type of service. Most often this takes the form of a video or animation sequence that is overlaid upon the camera of image of the print ad using Augmented Reality techniques. While this capability is new, there is great potential to enhance the value of a print ad by adding such an Augmented Reality (or AR) component. With the current approach, one augmented reality experience is associated with a print image (or what we will call a “cover” image). This is a problem because it is difficult to shape a marketing message that fits all viewers equally well. It is an object of the current invention to create a system that allows many AR experiences to be defined for a given print ad. When a user views the cover image through an AR viewer, the augmentation they experience is one that is tailored expressly for them. In this manner, a variety of video payloads or 3D-rendered animations can be associated with a print ad—and the one that is used is chosen based on a set of rules that leverages system knowledge of the user and the viewing circumstances to provide the best Augmented Reality experience for that viewer.
   7.8. Background and History
      7.8.3. Traditional Print and Video Experiences. Historically, traditional photographs have been a static experience. Photographic prints could capture an instant in time that could be preserved and viewed whenever desired. However, the fundamental experience was static and unchanging. Videos are an alternative to Prints. Videos can capture not just a moment in time, but a slice of time where motion and sound are also preserved. A video can preserve a richer and more immersive sampling of the user experience, but this experience could only be viewed with the appropriate video playback equipment causing this approach to be less accessible than simple prints, which are directly human readable. While the playback of the video is a more dynamic event, the content and total experience of that playback is constant and does not change with time.
      7.8.4. Augmented Reality. With the advent of computer technology, personal computing, increasingly powerful and connected Smartphones, tiny cameras and high resolution graphics processing capability, a new technology has been introduced that is commonly referred to Augmented Reality. Augmented Reality, or AR, presents a real-time view of the world as seen through a live camera feed and injects into that view graphical and pictorial elements that augment the original view presented by the camera. This creates a real-time visual experience where views of the world can be modified, annotated, and expanded. Smartphones provide a ubiquitous device that provides a powerful set of resources that can easily enable an AR Experience. The market is rife with new applications that leverage this technology to create new and valued customer experiences.
   7.9. New Photo-Video Experiences. One possible experience that can now be created is the blending of the traditional print and video experiences. A print can be made and when viewed with an AR viewer app on a smartphone, the view of that print in the camera feed appears to come to life as a video is projected onto the image of the print. What a viewer sees is a print that his held in their hand suddenly animating and showing a live video snippet. As the user moves the print within the camera field of view, the print is tracked and the video is projected onto this image using Augmented Reality methodologies that are well known in the art. This creates a convincing visual experience that is richer than the original view of reality as shown by the smartphone camera. With this scenario, prints and printed material can act as the gateway to a much richer media experience.
   7.10. Consumer Augmented Reality Photo-Video Experiences. With this as background, we can now explore the key elements of an AR Photo-Video system that allows consumers to leverage their own content. While this creates a personalized experience for their own use, it also allows the consumer to share these experiences with family and friends.
      7.10.3. Experiences Created with User Content
         4.4.2.5. Cover images. In the simplest form, the user takes a video and chooses a frame from within that video to print. The image thus chosen is referred to as the “cover image” and is associated with the rest of the video. Alternatively, an arbitrary image could be chosen that will then be associated with an arbitrary video. In this case, effort must be taken to ensure that the arbitrary image and video have a consistent orientation and aspect ratio to create a coherent Augmented Reality Experience. The cover image is usually marked with a watermark or other graphic so that when it is printed, users will know that this image has AR associated content. This then differentiates it with normal prints that have no such AR associated capabilities.
         4.4.2.6. Video Payloads. The video is trimmed to include the desired content and then cropped to match the cover image and encoded in a form that makes it available for video playback during the AR experience. At times this video payload can be stored or cached on the local device or in a Cloud Service where it can be downloaded or streamed to the device to deliver the AR experience.
         4.4.2.7. Playback. Playback occurs when the user uses an app on a smartphone or device with a camera that can provide real-time views. The camera view is then used to scan for prints in the field of view. Once detected, the print image has a recognition fingerprint calculated for it using perceptual hashing methods that are known in the art. This fingerprint is then compared with a database of previously defined and known cover image fingerprints and recognition occurs. Once recognition occurs. The video is fetched or streamed from its storage location to the smartphone or device, where an AR rendering system in the app plays the video and maps it onto the print image which is being tracked in the video feed. This augmentation plays out frame-by-frame in real-time creating the new user experience.
         4.4.2.8. Typical Uses. The user will typically capture or choose a video of interest, and chose a frame from that video to represent that key moment. This then becomes the cover image. The Cover image is a preserved memory of its own, but when scanned, this moment in time is transformed into motion and sound creating for a richer reliving of that moment. Another use is to take an arbitrary image and associate it with an arbitrary video payload. This allows the user to become creative in shaping the resulting experience, and the result is often useful for social interaction and sharing on social media.
      7.10.4. Sharing Content. Users can print cover images for their own use, or for sharing with family and friends, who can then scan the prints with an AR Viewer app to trigger the AR experience. This sharing can be done with actual physical prints or through an electronic sharing method. When shared electronically, the print image is shared via email, texting, or sharing using social media or other means. Once the electronic version is shared, the recipient can then print the image themselves, and then scan the resulting print to trigger the associated AR experience.
   7.11. Advertising Augmented Reality Photo-Video Experiences. The AR Photo-Video Experience can also be used by advertisers to communicate with consumers by using methods like those used for the consumer personal experience.
      7.11.3. Overview. While Augmented Reality Photo-Video experiences create value in the consumer space, it can be easily seen how such experiences might be leveraged to create value in the advertising and marketing space. An Advertising Augmented Reality Photo-video Experience is very similar in nature to the Consumer experience. While the cover image could take the form of a simple print, it most often would take the form of a print ad, a product label, a poster, a billboard, or even the image of a product itself. These forms are often used as advertising on their own, but ultimately, they are just as static as the traditional consumer print experience. Just as AR can be used to enhance and enrich the user experience with their own content, Advertisers can enrich their static ad experience by adding a AR Video playback experience. The ad is scanned and a video is projected onto the cover image in a fashion like the consumer case.
8. Problem Statement. While Augmented Reality Photo-Video Experiences add a new level of dynamism to the static print or print ad experience, they themselves also tend to be static. The current paradigm is to have a single video payload associated with a single cover image. Thus, the experience is the same for all users and this experience does not change with time. This is a limitation, and one can think of many circumstances where it would be advantageous to either deliver different payloads to different users, or to have a payload that can change based on time, context or changing baseline conditions. The current invention is aimed at creating a system that alleviates this limitation and allows for the Variant Delivery of AR Photo-Video Experiences.
9. Variant Payload Use Cases. There are many different conditions and cases where Variant Payload delivery would be valued. Several Key use cases are defined below.
   9.7. Use Case #1: Adaptive Advertising Content. This use case is focused on allowing for the creation of multiple payloads and allowing these different payloads to be targeted for various audiences.
      9.7.3. Targeted Payloads. Starting with a single cover image used in a print ad, an advertiser creates a series of different videos whose content is customized to better communicate a message to different groups of consumers. For example, different video payloads could be created that use different languages. In this way, one video payload could be created for the English Language, and other for the French Language. The idea here is that the viewing audience could be segmented on some basis and a custom video payload could be created for specifically for each of these segments.
      9.7.4. Rule-Based Selection of Payload. Once multiple payloads are created and associated with a given cover image, there must be some mechanism that selects which payload is to be used when creating the AR playback experience. While there are many such possible mechanisms, the preferred embodiment uses a rule base system that operates on a set of User and Scan-time metadata. As simple example, the gender of a user could be used to select the payload delivered, thus allowing for messaging that is better tailored for that user. There is a rich set of metadata and rules that could be defined drive such experiences.
   9.8. Use Case #2: Competitive Adverting Marketplace. In this use case, cover images are standardized and defined by the owner of a cover image. Different advertisers could then vie for the opportunity to associate their ad payload with that cover image.
      9.8.3. Cover Image Marketplace. Since the cover image is the gateway to the AR Photo-video Experience, the cover image space might be construed as a competitive marketplace, where advertisers vie to have their video payloads delivered when a cover image is scanned.
      9.8.4. Contests to Select Video Payload. In this scenario, an advertiser or brand could invite their users to create the best video payload for their cover image. The best submitted ads could be used as actual payloads. More than one content winner could be chosen and associated with the cover image. The payload selected for playback could be random or by selected through some set prioritization of those payloads with a probability that is correlated with their ratings and/or popularity.
      9.8.5. Payload Selection Fee Structure. In this case, a desired cover image is associated with video payloads that are sourced from various competing adverting organizations. For example, the logo of a sports stadium might be associated with multiple sponsors, all who have their own video payloads that they want to associate with cover image. The payload selection is this case may be based on probability measures that might be based on ad fee structures. For example, Top Tier pricing fee might get payload delivered 80% of the time, while Lower Tier pricing fee will deliver the ad 20% of the time. Obviously, there are many such selection probability schemes.
      9.8.6. Payload Selection Priority Granted by Auction. In this case, the frequency of display is driven by an auction process where the probability of ad selection is determined by a bidding process that establishes display probabilities.
      9.8.7. Payload Selection Priority for a Given Timeslot Driven by Auction. This use case would allow auctions to grant playback priorities for given timeslots. In this way, the day can be broken into different segments that can be won through a competitive auction. This could also work for days of the week or even for times of the year.
      9.8.8. Payload Selection Priority for a Given Location Driven by Auction. In this case, a specific location for a given print ad cover image is offered via auction. This allows yet another level of discrimination and control where some print ad locations might have greater desirability
   9.9. Use Case #3: Dynamic Media Channel. Rather than having a static video payload associated with a cover image, it would be possible to have the video payload change by replacing or supplementing original payload with new content. In this case, the cover image could be the gateway to a media channel containing new content over time by simply scanning the print. For example, vloggers would have a cover image that is essentially the logo for their channel. When the cover image is scanned, the most recent video blog entry would play. Pressing a button on the screen would also allow to you browse and access older video blogs.
   9.10. Use Case #4: Dynamic Content based upon Social Media Feedback. In this case, we focus on the notion that the payloads could change with time by incorporating Social Media Responses.
      9.10.3. Leveraging Social Sharing and Social Responses. Since cover images can be shared electronically, they can be shared broadly on various social networks. Such sharing often involves receiving responses from the viewer. This response might be a “like”, a comment, or it could even be a video response. Such reactions to an original posting are typically important and desired by poster. These reactions could be leveraged to extend or change the video payload.
      9.10.4. Evolving Payloads. The original video payloads can be modified by extending the video to show text comments along with the user profile name and photo of the person who made them. A chart of who “liked” the post could be added to the video and video responses could also be appended to the original video. Using these or similar methods, social interactions can change the nature of the playback and drive a continued interest in scanning the cover image to see what has changed.
   9.11. Use Case #5: Augmented Recognition based on Scene Text or Graphic Recognition
      9.11.3. Recognition Limitations. Different image recognition technologies have differing capabilities. For example, creating a unique image recognition signature for an image may involve removing color information, cropping the image, or reducing its resolution prior to the computation of the image fingerprints. These engineering decisions can make the recognition engine operate faster but they can also make the engine relatively insensitive to some forms of visual information. One example could be text contained within the image. Text that is perfectly readable by humans or even machine read using standard Optical Character Reading (OCR) algorithms might not be useful detection features for some image recognition solutions where the resolution has been reduced significantly to speed up the recognition process.
      9.11.4. Supplementary Text Recognition. Text detection and Optical Character Reading (OCR) technology is well known in the art. It is possible to run a text detection and extraction algorithm on the cover image in addition to the standard image recognition analysis. This then would produce Extracted Text Metadata in addition to the Cover image recognition fingerprint. This additional information can then be used to select the payload that is to be delivered. An example of this might be the recent marketing campaigns where a soft drink manufacturers created bottles with your name on the label. When the image of this bottle is used as a cover image, it could be recognized as the correct branded image but would not have the ability to differentiate between similar bottles that have different names printed on the them. By using the combination of text detection and extraction technology, the name can be detected separately and this data can be used in conjunction with the image recognition signature to deliver the right customized payload.
      9.11.5. Supplementary Graphic Recognition. In cases where the image recognition logic is blind to certain graphical features, such as color, or texture, it is possible to use existing template matching or similar technologies to extract those features independently of the Image Recognition effort. This would produce supplementary data that can be used the payload selection process.
10. Key Elements of a System that can deliver variant payloads
   10.7. Key Elements of the System. The key elements of a Variant Payload Advertising system are Cloud Services, a Smartphone App for the user, and a Web App for the Advertiser. These system components must have connectivity to interoperate. It is to be understood that the functionality of the system can be segmented and allocated in a variety of ways, however these key elements would still be used to create the system.
      10.7.3. Cloud Services. The core of the system is built around Cloud Services. This broadly accessible and scalable set of compute resources form the hub and the backend of the system, and contain key control, compute and data storage functions.
      10.7.4. Consumers. Consumers are system users that are the target of the delivered Variant Payload Augmented Reality Ads. The primary system user interface for the Consumer is the Smartphone or Smart Device App.
      10.7.5. Smartphone App for the Consumer. Smartphones have become extremely power connected and ubiquitous compute platforms that carried and relied upon by the user. Smartphone provide a rich graphical user interface, along with increasingly capable cameras that are a key resource to enabling Augmented Reality experiences. In addition, Smartphone has a rich set of sensors such as GPS, Accelerometers, and digital compasses along with environmental sensors, all of which can provide useful metadata about the user or the Augmented Reality Scan experience. It should be noted that the smartphone category can be expanded to include other classes of smart connected device such as small or full size tablets and even small laptop computers. The smartphone or device is used to run an app that controls the variant payload delivery experience for the user.
      10.7.6. Advertisers. Advertisers are system users that sponsor, create, manage and benefit from Variant Payload Augmented Reality Ads. They target specific consumers and create ad campaigns that drive the delivery of the final Augmented Reality experience to the consumer. The primary System User Interface for the Advertiser is the Web App.
      10.7.7. Web App for the Advertiser. A standard web app that can be accessed by a

Web browser from computer or smart device is used as the primary interface for Advertisers. It allows advertisers to access the system and to create and manage ad campaigns as well as access analytic data that reports on the success and reach of current or past campaigns.
10.7.8. System Connectivity. To form a system, these components must be linked together. Consumers are linked to their Smartphone by direct physical interaction with those devices. Advertisers are linked to the system by accessing browser-based Web Apps that use a computer or other smart device to access the cloud via the internet connection. Smartphone and Smart devices access the cloud through internet access provided either by a cellular local Wi-Fi connection. Faster Internet connections will provide a better experience for both Consumers and advertisers as media files (video and cover images) are sent in real-time. Security, Privacy, and data protection interests are best served by secure connections such as provided by SSL 3.0 or other methods.
10.8. Cloud Subsystem
   10.8.3. User Accounts. Access to Cloud resources and data must be protected to create a secure system. This is accomplished by access through secured internet connections and the use of account authentication. Users of the system, either Consumers or Advertisers, must create an account with verified user data. Access is associated through these accounts.
      4.4.2.5. Authentication. User account will have a user name and a password mechanism to authenticate users and provide authentication tokens for subsequent Cloud service calls.
      4.4.2.6. User Data. The user account creates an identity for each user. The system can then accumulate and store user specific information. This user information can be used to enhance the user experience for both consumers and advertisers.
      4.4.2.7. User Provided Account Information. As a part of the account creation process, or as a part of follow-on user engagement, the user can explicitly provide key pieces of information about the user. This includes key demographic and contact information such as: name, user names, email addresses, phone number, gender, age, home location, personal statements, birthdays and more.
      4.4.2.8. User Profile based Upon User Behaviors. The user's behavior within the system can also be analyzed and profiled. These behaviors can be associated with how much printing and sharing they do, how often they react or respond to media shared with them, how often they leverage social networks, their friends and followers, etc. This captured behavior can also deal with how the user interacts with Augmented Reality Ad content. The behavior can provide user metadata that can be leveraged for Payload selection decisions as well as other marketing uses.
      4.4.2.9. User Profile based upon User Media Analysis. The system will be able to access the user's media that is stored on the phone, in the cloud and on various social network sties. This media is a sampling of the user's life and constitutes a valuable resource for profiling the user. Each piece of media typically will have metadata that records the time and date that the media was captured or created. Increasingly, location information is also available. The media itself, either in still images or in video, can be mined for content that would be useful for user Profiling.
   10.8.4. AR Entity Creation. For the system to be able to deal with Augmented Reality Print experiences, it must allow for the creation of such experiences. Creation is a process that contains several steps such as:
      Submitting a cover image
      Validating that the cover image is suitable for Image Recognition
      Creating a cover image fingerprint
      Storing the fingerprint in a high-speed index to enable future searches
      Storing the Cover image in a cloud store
      Uploading one or more video payloads
      Trimming and cropping the video so that it matches the system length requirements, and the aspect ratio of the cover image.
      Encoding the video to optimize storage, streaming and download characteristics
      Saving the video(s) in a cloud data store
      Saving the video payload selection rules
      Create a master database to bind together all key data about the entity.
   10.8.5. Media Database. As users leverage the system for their own purposes, they will create or upload new AR entities and still images. In addition, they will expose their own content that may be stored in the Camera Rolls or located in Social Network Applications. As these are exposed to the system, they can be stored either on the cloud or on the smartphone. Making sure that the user's access to their content is easy and convenient is important to enhancing the user experience. Therefore, it is important that media used by the system is stored in the cloud for future use.
   10.8.6. User Media Analysis. This is a service that runs in the background to analyze accessible user media for the purposed of creating new metadata and adding this to the user profile to enhance payload selection. This module can leverage an ever-increasing set of existing 3^{rd} party services to create richer user profiles.
   10.8.7. Image Recognition Services. This service is a key enabler of the Augmented Reality Print Experience. The cover image must be recognized so that the associated video payload can be selected and delivered. Typically, the consumer app will own the functional responsibility of sensing a print coming into the camera's field of view and tracking its location. From this video feed, a version of a potential cover image is extracted and normalized for viewpoint perspective and lighting distortions. The normalized image is analyzed to create a fingerprint of the prospective cover image. Such fingerprints are typically based upon scene features that are invariant to exposure and position and based upon the core technology of Perceptual Hashing. They are many variants of this technology known in the Art, or available as 3^{rd} party services. The fingerprint is then sent to the Cloud Recognition service. The Recognition service uses a hash-based search to quickly find the best match to established fingerprints in the index. The match is either found, allowing experience to enter the next phase, or it is not, which causes the service to report the failure to find a match. The call to recognition services includes user account information as well as scan-time metadata. This information will be used in the payload selection process.
      4.4.2.5. Hybrid Recognition. In some applications, the image recognition can be augmented by an additional text detection/extraction step or a graphical template recognition step. This would be run in parallel with the normal image recognition logic and would operate on potentially higher resolution information, the results of which can augment the fingerprint match work of the normal image recognition process. The results of this Augmentation would be a state variable indicating that augmented recognition has been done and metadata around what was found in this process. This metadata can be used in payload selection rules.
   10.8.8. Payload Selection. All established AR Entities will have at least one payload associated with the cover image. They will also have payload selection rules defined as part of the AR Entity data structure. When there is only one payload associated with a cover image, this selection rules can be extremely simple—basically just using the only payload available. However, when multiple payloads are defined, there must be criteria defined to drive the selection process. This typically takes the form of a set of rules if-then-else rules that perform logical operation on user and scan-time metadata to select the correct payload.
   10.8.9. Metadata Types. It is useful to explore the kinds of metadata that might be used in a Payload Selection System.
      4.4.2.5. User Demographics. Since an app is used to enable the Augmented Reality Experience, it is possible to have the app capture specific data about the user and their preferences. This user data is typically entered by the user as a part of the account creation process. This process can also secure the user's permission to use this data as it's use will drive a more positive experience for the user. The app can then use this information in determining payload selection, this user data can include such things as gender, age, birth date, and user preferences. This category could be expanded as needed assuming the user is willing to provide the requested information.
      4.4.2.6. User Profiles created by Image/Video Assets Analysis. Systems that support consumer Photo-Video AR experiences often require users to create an account. Media associated with printing, sharing and AR Product Creation are typically either stored as part of that account, or the account is given access to other locations where media is stored. The resulting collection of media that is very user centric, and a valuable source of potential user information. It represents a sampling of their life experience. Using Image, audio-video analysis tools, this media can be processed and analyzed to create a unique profile of the user. Services offered by Google, as an example, allow content to be scanned and tagged based upon image recognition, text recognition and extraction, consumer product logo recognition, and similar capabilities. This could be used to build a unique profile by user that can then be used to drive alternative Payload delivery.
      4.4.2.7. Time based. This can refer to date and time of day. Thus, payloads could be selected differently for daytime versus evening, or it could change based on the season or proximity to a holiday, or it could deal with a relative measure associated with the phase of the ad campaign.
      4.4.2.8. Location based. This metadata gets at location. In some cases, this can refer to macro-level issues such as Localization/Regionalization such as country/nationality, language and culture. In other cases, it may deal with micro-level issues such as where and ad was viewed. This can tell us about which poster or billboard was scanned, or it could tell us where a print ad was viewed (home, coffee shop, or Hotel). In other cases, the location can be used to select payloads that are associated with specific retail outlets that are nearby.
      4.4.2.9. Recognition Augmentation Data. Metadata extracted by a separate and parallel text or graphic detection and extraction process which provides augmented recognition metadata.
   10.8.10. Example Rules. There are many such possible rules that can be defined by someone knowledgeable in the programming arts, below are several examples to illustrate this mechanism.
      4.4.2.5. Gender Based Selection:

If (user.gender == MALE) then

Select payload A

Else

Select Payload B

4.4.2.6. Age Based Selection:

If (user.age > 65) then

Select payload A

Else If (user.age > 30) then

Select Payload B

Else if (user.age >20) then

Select Payload C

Else

Select payload D

4.4.2.7. Region Based Selection:

If (user.region == France) Then

Select Payload A

Else if (user.region==Germany) then

Select Payload B

Elsie if (user.region == Italy)

Select Payload C

Else

Select Payload D

4.4.2.8. Time or Date Based Selection
4.2.8.4.1. Time based Selection:

If (scan.time > 6:00PM) Then

Select Payload A

Else

Select Payload B

4.2.8.4.2 Date based Selection:

If (scan.date.month == DECEMBER) Then

Select Payload A

Else

Select Payload B

10.8.11. Payload Delivery. Once selected, there must be a mechanism to allow the video payload to be delivered to the user, which involves transferring the video data from Cloud Storage to user app running on the smartphone or device. The essential feature here is that the data be transferred and there are many ways that this could be accomplished, however some methods can have an impact on the final consumer experience.
   4.4.2.5. Download. The simplest method is to simply download the data file. Most typically, the entire file is downloaded in its entirety before playback of the video can occur. Some form error detection is used to verify that the data received has not been corrupted in transit. This could take the form of checksums for either the entire file or for each block of data transferred. The disadvantage here is that video files can be large and the transfer can take some time to accomplish. This causes the user to have to wait for the download to be completed before video may be viewed. Alternatively, some systems allow for one or more blocks of data to be buffered and video playback to occur while the remainder of the data is still downloading in the background.
   4.4.2.6. Streaming. Another alternative is streaming, where a stream of data is sent out from the server in real-time. The receiver collects the data and begins playback in real-time so that there is no delay in the start of playback. This form of transfer can be very efficient and create an excellent user experience if the data can be streamed out faster than it can be played back. If this not true (usually driven by local network bandwidth conditions) then the video playback can stall, creating a negative user experience.
   4.4.2.7. Adaptive Streaming. Another method of steaming that can be used is adaptive. In this case, the local bandwidth of the network connection is monitored in real-time and the bit-rate of the streamed data is modulated to optimize data transfer when network transfer speeds change. This can be the most efficient and create the best user experience.
   4.4.2.8. Caching. Once a video payload has been downloaded or streamed for playback, it is sometimes useful to cache this payload locally on the Smartphone or device. If users should scan the cover image again, the payload can be pulled from the local cache thus avoiding an additional download or stream process. Such caches are typically purged as entries age.
10.8.12. Ad Location Proximity Services. Print Ads can take many forms such as those that have no set locations, such as magazine ads and product packaging. There are others, however, such as Billboards, Posters, Point-of-Sales material that are fixed in their location. In those cases, there is the opportunity to register such locations as part of the Ad definition. This provides the opportunity for the user app to notify the user as to those ads that might be in their proximity. One way to do this is to have a pop-up in the user app that notifies the user of an ad that is nearby so that they could scan and view the add. The app could also show a map of the current location and display on this map the location of ads that are nearby and provide guidance to the user to find those ads. For this to work, this service is called by the user app along with the current location of the user as defined by the GPS resource on their phone. The service to compares this location with the location of nearby ads and responds with the location of all ads located within some defined distance radius.
10.8.13. AR Playback Logging and Analytics. While it is extremely important to build the system to both create and deliver AR Variant Payloads, it is also important to instrument the resulting system so that Advertisers can understand the nature of ad delivery. The system must be designed to log each playback event along with critical metadata. Information that can be captured includes:
   Playback Metadata:
      Specific Ad triggering playback
      Specific campaign that ad is a part of
      Device type and OS
      Time/date of playback
      Location of the playback
      Duration of the playback (how much of the video was watched?)
      Which payload was selected
      Whether the Call-To-Action was used
   Consumer Metadata:
      Consumer demographic information such as gender and age
      Feedback collected by the app in the form of “likes” or user comments.
   Other information which is useful can be included in the logged information. This captures key information for each ad playback. The system must also be designed to generate key analytics that allow the population of viewing events to be summarized and tracked. It is expected that when the Advertiser logs into their account on the Advertiser web app, they will be able to view a dashboard for each campaign and ad that presents summarized data and access to presentations of other data relative to the performance of the campaign and specific ads within that campaign. The Advertiser can then use this data to measure the success of the campaign and even allow them to adjust and modify the campaign by responding to this analytical data. This data is critical for the Advertisers, but is also important to the owners of the system, as it allows them to better understand how the system is being used, and in some cases, can be the basis of Performance-based billing. Performance-based billing is the concept where the advertiser is charged more for ad campaigns that have greater success and reach more targeted users.
10.9. Smartphone Subsystem
   10.9.3. Smartphone Resources. Modern smartphones have evolved into extremely capable compute platforms that are connected to the internet. These devices are provisioned by the user and can be leveraged as critical resource in the Variant Payload AR delivery system.
      4.4.2.5. Compute Resources. Modern Smartphones and Smart devices have increasingly powerful computer resources. These include fast multi-core CPUs, graphics co-processors, large memory and storage spaces and even custom processors to handle AR and Sensor inputs. These can drive the app that derived the Variant Playback AR Experience.
      4.4.2.6. Camera. Effectively, all smartphones now include one or more cameras that offer high resolution capture of images and video streams. This proves to a be a critical resource for two main reasons. First, a live video stream is needed to scan the cover image and support the detection and recognition of cover images. Secondly, the video steam is the foundation of the AR Playback experience. This stream is modified in real-time to produce the desired effect.
      4.4.2.7. Graphical Interface Screen. Smartphones now offer large, colorful, high resolution touch screens that are a key resource for the creating Graphical User Interfaces to interact with the user and to present the AR experience built upon the live camera feed.
      4.4.2.8. GPS. Smartphone typically contain GPS receivers and operating system support of various location services. These in combination, provide not just location, but broader context on where the user is in the world at any given point. This information can be used Payload selection purposes and for Playback logging as already described.
   10.9.4. Smartphone App. The Smartphone app is the primary interface for the consumer user.
      4.4.2.5. Login and Authentication. Since the app must access the system's cloud services to function, and to access and share key pieces of data. To do this safely and securely, the app requires the user to establish a user account and setup of login credentials that will both identify the user to the system and allow for secure interactions. The app requires the user to log into the account and uses cloud services to authenticate the user, and to provide security tokens that are used by the app to make secure cloud calls and to allow other devices owned by the user to access the system. For example, the user may have a Wi-Fi enabled printer or a set of Augmented Reality Glasses that could be used with the app, and app can provide such security tokens that will authorize these devices to work in a secure way associated with a given user account. The app must support not only user logins and authentications, but must also support the on-boarding process for a new user such new accounts can be created, credentials certified, and basic user information captured and associated with the account.
      4.4.2.6. Access to User Media. For the purposes of Payload Variant AR delivery, it is useful to have access to the user's media so that it may be analyzed for the purposes to enhancing the user profile. This profile can then be used to play a role in payload selection.
         1.13.2.2.1. Camera Roll. Most smartphones have what is called a “camera roll” which acts as the primary repository for media (still images and videos) captured by the device.
         1.13.2.2.2. Social Network Media. Often media is now shared on Social Media web sites associated with the user's account on those services. Many such social network sites allow for Cloud Service API's that allow other applications to have access to content stored on the social network. This capability can be used to enrich the collection of media used for user content media analysis to further populate the user profile.
         1.13.2.2.3. Media Printed and Shared within App. The Payload Variant AR App itself allows user to create their own AR Photo/Video experiences with their own content. The media used for these creations can be stored by the Payload Variant AR system, and this media can also be included in the media analysis.
   10.9.5. AR Entity Creation. For consumers to play back and be exposed to Variant Payload Ads, they must fundamentally understand the concepts around Augment Realty images being enhanced by video. They must understand that designated images can be scanned by the app to unlock a richer media experience that is presented leveraging these Augmented Reality methods. One way to do this is to allow the user to create their own Augmented Reality images that they can have for their own use or to share with friends and family. As such, the Consumer App allow for such creation. This educates the users about the entire experience and removes a barrier to consumers understand how to access AR Ad content.
   10.9.6. AR Entity Modification. The app can allow the user to modify an existing AR entity that they created and own. This could be a simple as deleting the entity, but there is no reason that the user could not be given the ability to edit a current entity by swapping out the video payload. The video could also be shorted by trimming or it could be augmented by allowing the user to designate social feedback received for the entity and the app can use this input to extend the video showing how various people have responded with text, sound, or video snippets being added to the end of the video.
   10.9.7. AR Entity Scanning. A key functional element of the app is the ability to use the live camera video feed to scan for and recognize cover images of AR Entities. When detected and recognized, the app then plays back the selected video payload and creates an AR experience. This process consists of several key elements.
      4.4.2.5. Print Detection, Tracking and Extraction. The camera feed must be analyzed in real-time so that views of possible printed cover images or ads can be detected and tracked in the camera field of view. There are many methods available in the art that could be used for this purpose. When a candidate image is detected, the app does two things, it tracks the location in the camera field and it extract a copy of a still image that is a good representation of the candidate image. This selection can come from many possible video frames, so metrics are computed for each frame to aid in the selection of the best for use. Selection criteria can include sharpness measures as well as exposure measures.
      4.4.2.6. Print Image Normalization. Once extracted, the resulting image may have distortions. The position of the printed image may be rotated and tilted causing the final image to not be straight and to exhibit geometric distortions such as “keystone” effects. Since these distortions can make the image harder to recognize, it is often advisable to apply a geometric transform that will normalize and standardize the presentation of the candidate image. Other normalizations may include tone scale and color adjustments.
      4.4.2.7. Cover Image Recognition. The next step is performing the Cover Image Recognition function. This will consist of several steps that ultimately determines if the candidate image matches one that has been defined by the system and associates that image with a payload.
         10.9.7.7.0.1. Image Fingerprint. One critical step is to compute the fingerprint of the image. The fingerprint is a form of perceptual hash code that based on invariant features of the image. There are many commercial services that can be selected to support this step.
         10.9.7.7.0.2. User Metadata. User metadata, as already described, is then accessed by the app and placed in a data structure for use in the recognition process.
         10.9.7.7.0.3. Scan-Time Metadata. Scan-Time Metadata, as already described, is collection by the app and placed in a data structure.
         10.9.7.7.0.4. Augmented Image Recognition Metadata. Additional Metadata returned by separate and parallel text or graphics detection/extraction logic run at scan time.
         10.9.7.7.0.5. Cover Image Recognition Service Call. The parameters listed above are included in the call to the Cloud Service Cover Image Recognition call. The Cloud then determines if there is a match. If there is, a success code is sent and the app prepares to receive the Video payload.
      4.3.5.4. Image Tracking. During the recognition process, the app continues to track the location of the candidate cover image in the camera field. This is necessary as the coordinates of the image at any point in time will be needed to align the AR projected video over the top of the cover image should recognition be successful.
      4.3.5.5. AR Playback Rendering. Once video data is available (either through a streaming or download process), the app will feed this video to AR Playback rendering engine, which will transform the video frames in image augmentations that are applied in real time over the position of the candidate image in the camera field of view.
      4.3.5.6. Call-To-Action. Once a cover image is recognized, the video transfer begins and data associated with a call-to-action is also sent to the app from the cloud. Call-to-Actions allow the user the option of easily going to a website to get further information or to make a purchase. Call-to-Actions are defined by the advertiser and associated with a specific ad definition and are created through the Advertiser Web App interface. Call-to-actions can consist of many things, but the most critical elements are: 1) Graphical Button Definition, 2) A web link (URL) to be associated with the button, 3) a time when the button should appear on the screen.
         4.3.5.6.1. Graphical Button Definition. This consists of graphical element that should be displayed on the screen at a given size and position on the screen. Since this display represents a clickable button screen element, the app should not only display it, but sense when a click or a finger press event has occurred in its defined space. This will then trigger the Call-to-Action event.
         4.3.5.6.2. Web Link. The web link is the location on the World Wide Web that the app should vector to if the Call-to-Action button is clicked. Should this occur, the app will launch the default web browser on the smartphone and go to the designated page.
         4.3.5.6.3. Time to Display Button. This parameter tells the app when to display the Call-to-Action button. This time is relative the playback of the video payload. For example, in some cases it could be set to display only after the video payload playback is complete. In other cases, it might be defined to display as soon as the video playback has begun. It could also to set to display at various point of the video.
         4.5.6.1. Call-To-Action Analytics. Since the app knows when a Call-to-Action button has been pressed, it can log this information and report it back to the Cloud Service so that this action is known. This is information ads to the analytics that of are interest to the Advertiser.
      4.3.5.7. Consumer Feedback. Once the ad is recognized and played, the app will show buttons on the screen that allow the user to either “like” the ad, or to make a comment on the ad. In the case of the comment, the user will have the ability to ad text, emoticons, or other feedback. This feedback from the consumer is returned to the Cloud system via a cloud service call and the feedback is stored as part of the Analytic data set for the ad viewed.
   10.9.8. Printed Ad Proximity Radar. Since some print ads are set at fixed locations, these specific locations are known by the Cloud Service. This allows a feature in the app where the user can be alerted to the presence of ad when they are in the general vicinity. To accomplish this, the app can send the current location of the user to the Cloud Service. The Cloud Service can then determine which print ads are in the general vicinity and pass those ad coordinates to the app. There are many ways the app can use this information to call attention to print ad proximity. The app could trigger a pop-up notification. Another possibility is to have a “radar” like mode that shows the location of the user on map view, along with the location of various print ads in the area. The user could then be directed to the ad of their choice. These ad proximity checks can be done on a periodic basis or only when requested by the user. All ads that are in the vicinity could be identified or the user could filter the view of the types of ads they are interested in.
10.10. Advertiser Web App
   10.10.3. Advertiser Account Creation and Authentication. Access to Cloud resources and data must be protected to create a secure system. This is accomplished by access through secured internet connections and the use of account authentication. Users of the system, either Consumers or Advertisers, must create an account with verified user data. Access is associated through these accounts.
      4.4.2.5. Authentication. User account will have a user name and a password mechanism to authenticate users. The Web App must support not only user logins and authentications, but must also support the on-boarding process for a new user such new accounts can be created, credentials certified, and basic user information captured and associated with the account.
      4.4.2.6. User Data. The user will be required to supply specific information when an account is first created. This information will include name, address, company, email address, phone numbers, payment options (i.e. credit card), and so on. This provides all information needed to establish a business relationship. In some cases, this information may need to be validated before the account can become active. But once the account is active and the user logs into the web app, a virtual environment is created that shows that user previous Advertising projects that have been completed, Adverting projects are currently active, and projects that are currently being worked upon. For currently active and past project, the analytical data for those efforts is available.
      4.4.2.7. Advertiser Analytics. The Web app creates an environment for the advertising user to operate in. The actions of that user within this environment as has its own value in terms of Analytical data. As such, the actions of the user are logged and made available to managers of the system. This analytical data can consist of, but not limited to:
         Time spent in the app
         Time spent on a given screen or app view
         Details of campaigns run
         Details of campaign options used
         Changes made during the execution of a campaign
         Ad Analytics used or requested
         Support requests
         Etc.
   10.10.4. Ad Campaign Creation. One important function of the Web App is to allow the advertiser to create ad campaigns. Ad campaigns have a Title, a duration, the number of print ads, associated video payloads, rules for selecting the payloads, Call-to-Action links, Print Ad locations, and Costs.
      4.4.2.5. Dates. Ad campaigns typically are run for a fixed duration. They have a starting date and an ending date. Services required for the campaign must be available for this time. This time period can also be a key factor in driving the fees charged for this service.
      4.4.2.6. Number of Print Ads. Ad Campaigns will consist of several ads that form the key communication elements of the campaign.
      4.4.2.7. Type of Print Ads. Ads can have various types which can drive certain details that may need to be defined in some cases and not in others. For example, ads may be:
         Magazine ads: Ads that are designed for use in Magazine publications. These are normal print ads and specific ad instance locations are not known or relevant.
         Product Packaging Ads: These are image of product packaging. These are normal print ads and specific ad instance locations are not known or relevant.
         Product Label Ads: These are images that are on product packaging. These are normal print ads and specific ad instance locations are not known or relevant.
         Point-of-Purchase ads: These are normal print ads that maybe displayed in locations where the product can be purchased. As such, there is an option where specific ad instance locations can be known and leveraged.
         Billboard Ads: Standard Print ads where the specific ad instance location is known and leveraged.
         Business Card Ads: These are normal print ads and specific ad instance locations are not known or relevant.
         Product Instruction Ads: these are ads that are placed in instruction sheets and user manuals. These are normal print ads and specific ad instance locations are not known or relevant.
         Open Market Ad—Cover Image Owner: In this case, the owner of a cover image can post the cover image to an Open Cover Image Marketplace. Payload creators can then access this marketplace to apply to have their payloads played when those cover images are scanned. (see later description). Specific Ad instance location may be leveraged.
         Open Market Ad—Payload Owner: In this case, the Payload Owner looks for a cover image in the Open Cover Image Marketplace that they want to associate their ad payload with. (see later description).
         Media Channel Ads: This type of ad allows many payloads to be associated with a single cover image and the selection rules wills elect the most recently defined payload. When the Consumer App recognizes the cover image, it will also be told that this is from a media channel and a list of other payloads will be sent to the app. The App then allows the user to optionally select other payloads in the list.
         Recognition Augmentation Ads: Hybrid ads use the cover image fingerprint to select the list of possible payloads but also uses auxiliary scan-time information from text extraction or graphic template matching to make payload selections.
      4.4.2.2 Open Market Cover Images. The normal mode of operation is to have an advertising user own and use their own cover images and payloads. However, there are times where cover images can have their own value and owners of those images could make them available for use by others by creating an AR enabled ad. In this case, the Advertiser Web App creates a Marketplace so that Cover Image Owners can offer use of these cover images to Advertisers that would like to associate a payload for those images. The images are offered with an interface very like any web store. Cover images can be browsed or filtered and searched for via keywords or tags. When an entry is selected, the offering describes the terms by which the cover image is made available. In some cases, it might be a flat fee for use. In other cases, a fee may be associated with the probability of your payload being selected. Fees can be for global access, or the fee structure could for specific timeframes, locations, viewer genders, etc. An alternative method is to offer a payload slot up for auction, where payload owners bid for use of the cover image and the highest bid wins the right for a payload being used for the cover image slot.
      4.4.2.3 Set Cover Images. The cover image is one of the key elements of AR Variant Payload Ad deliver. This is the image that is printed and creates the face of the ad. This image must be validated by the system to ensure that it has sufficient features and characterizes such that the image recognition method will readily recognize the image. The cover image is selected by the Advertiser for each element of the ad campaign and uploaded to the system. The system will then validate that this image suitable for its intended use. The image is a fitness score that provides feedback to the advertiser. In some cases, the image may be rejected by the system as unsuitable. Alternatively, it may be given a low score. The system can provide guidance to the advertiser so that good cover images are selected that not only meet advertising needs, but also meet the technology requirements of the cover image recognition methods used.
      4.4.2.4 The Open Market Ad Cover Image Owner mode. Once a cover image is accepted, if the Ad Mode is Open Market Ad—Cover Image Owner, then that cover image is entered into the Open Market as an available cover image. The user is then prompted to enter information how a payload creator can find and use this cover for their ad payloads. This will include information on fee types (flat, auction, etc.), and access segmentation based upon play back probabilities, time channels, location channels, and associated info. Based on the terms of use defined for a given cover image, the Payload selection rules are selected and specified by the Cover Image Owner.
      4.4.2.5 Open Market Ad—Payload Owner Mode. If the mode is Open Market Ad—Payload Owner Mode, the use is directed to the Open Market Ad Browser to select the Cover images of interest. As these are displayed, the terms for their use are also displayed. Once chosen, the user reviews the terms and either accepts them and or moves on. One accepted, the cover is chosen for the ad under creation and moves on to the next step of choosing the payload. If the fee is based upon an auction, the advertiser can place a bid but they cannot complete the creation process until the auction is concluded and use of the Cover image is granted.
   4.4.3. Set Payload(s). Each Ad must have at least one video payload. The payload will have technical requirements that must be met, and the system will allow the user to upload the video or videos desired. The input requirements may specify what resolution, aspect ratio, duration, or encoding might be accepted. In some cases, the advertiser may have to have pre-processed the video assets to meet the requirements. Alternatively, the app could accept a broad set of criteria for upload, but then guide the user through the changes necessary to make this video useful for the ad desired. For example, the video might have to be trimmed for length, zoom or cropped for aspect ratio fit, re-rendered for resolution, and re-encoded to meet system requirements. More than one video can be specified.
      4.4.3.1 Open Market Ad Case. In the case of Open Market Ads, the Payload owner can associate their payload to a selected Open Market Cover image if they have committed to terms specified for that cover image and have been granted access.
      4.4.3.2 Dynamic Media Channel Case. In the case of the Dynamic Media Channel, users can create, add to, and modify an list of payloads over time.
   4.4.4. Set Payload Selection Rules. If only one video payload is specified, then a default selection rule can be applied and the advertiser need not deal with this area. However, if multiple payloads are defined, then a set of selection rules must be defined for each payload. A set of common selection rules can be offered to the advertiser for ease of use, but the option of creating custom rules is also available. Rules consist of logical operations that can be performed on a set of user or scan-time metadata in the form of If-then-else tests. For Open Market Ads, the Payload Owner does not set the payload selection rules, rather they sign on to specific use terms for a given payload and these terms will hold the specified payload selection rules. For Dynamic Media Cannel Ads, the rules can specify which of a list of payloads should be played at any given moment.
      4.4.4.1 Set Call-to-Action. For each ad, the advertiser can choose to add a Call-to-Action. These take the form of graphical button that is overlaid on the ad video playback—these buttons can be selected by the viewer of the ad to get more information or to allow purchase of a product or service. The system will some pre-defined and commonly used graphic button to choose form or the user can upload a custom graphic to use for the button. The advertiser will also specify a URL that the vector the user to the desired web site. Finally, the Advertiser can define where the button should be displayed and when it will be displayed within the context of the video playback. For Open Market Ads, the Payload owner specified Calls-to-Action if their payload is selected.
   4.4.6. Set Print Ad Locations. Based on the type of ad selected, the advertiser may have the option of defining geographical locations for the various print ads planned and can subscribe to a service that notifies users of the proximity of one of those ads. For Open Market Ads, Ad Locations are tied to the Cover Image terms of use. In the case of Open Marketplace Ads, the location may be specified in the terms offered for a cover image.
   4.4.7. Ad Previews. As ads are being defined, it can be vary useful to have the ability to prototype what the ad would look like to a consumer viewing. To support this capability, the user can take defined ads and trigger them within the Web App. As part of this process, they can enter or select user or scan time information so that they can simulate the different aspects of the variant payload delivery. The ads will then play back based upon the payload selection rules defined for that ad, and the Call-To-Action will be shown as specified. The call-to-action can also be triggered to verify that the defined UR is correct and the resulting page view is as desired. This simulation allows the users that the ad definitions will accomplish the goals for ad given ad or ad campaign.
   4.4.8. Notifications. The user can setup key waypoints and events in the campaign that will trigger notifications to the user. For example, this might include flagging events such as when certain levels of ad access have been achieved, or that the end of a specific campaign was approaching or even just reporting out of daily ad totals. The form of notification can also be set. These would include emails, or text messages to specific phone numbers.
   4.4.9. Payment. Once the campaign is fully created and specified, the advertiser can see what the total cost of the ad campaign will be. At this point, payment for these fees can be authorized and the ad campaign will be enabled.
5. Ad Management Interface. Once an ad campaign is created and authorized, the advertiser can review and manage aspects of the ad. The Web app will provide a list of currently enabled campaigns, and once selected will be presented with a campaign management interface that will allow the user to view analytics around the current campaign, and tools that will allow for modification of that campaign.
   5.1. Analytics Dashboard. As consumers interact with ads, there actions are recorded and this information provides the basis for analytics around the campaign. Top level metrics around these analytics can be presented in dashboard view that makes it simple for the advertiser to get a sense of how the campaign is going. It can also allow the user to request and view more details analytical data that can be presented in various forms that would be useful in helping to understand campaign performance trends. This information can be used by the advertiser to manage and even modify the campaign while it is underway. Analytics data could include:
      Number of ad views
      Number of unique ad viewers
      Time distribution of views
      Location distribution of views
      Percentage of the video payload viewed
      Call-To-Actions that were clicked through
      ‘Likes’ for the ad
      Comments made on the ads.
      Etc.
   5.2. Modify Campaign. The Advertiser is provided with several options that allow them to modify the active campaign.
      5.2.1. End Campaign. If the campaign has already met advertising goals, or it the campaign is clearly not achieving campaign goals, the advertiser can choose to end the campaign prematurely, thus saving on ad costs.
      5.2.2. Modify Ads. Alternatively, the advertiser may choose to modify various aspects of the current ads in the campaign.
      5.2.3. Eliminate or add new Ads. Some ads may not be effective and they can be eliminated. Additional ads can also be defined and added to the campaign.
         5.2.3.1 Cover Images. Cover images can be modified or changed.
         5.2.3.2 Payloads. Payloads can be swapped out, added or removed.
         5.2.3.3 Payload Selection Rules. The rules for Payload selection can be modified and refined.
         5.2.3.4 Modify Call-To-Action. Call to actions can be removed, added, or changed as needed.
         5.2.3.5 Modify Date and Duration. The campaigned can be extended or shortened as desired.
         5.2.3.6 Open Market place Ad Status. Cover image Owners and Payload owners will have a view that allows them to track Open Market ads that they are current.
6. Data Flow Through the System. To further explain the current invention, we can follow an example of how the data flows through the system when a consumer is using the application and scans a print ad with the Smartphone Application.
   6.1. User Login. In our example, the user has already created an account on the system and has already logged into the app. This allows the system to authenticate the user, access user profile metadata that has been previously entered by the user, and provide the app with authentication tokens that allow the app to access system cloud services.
   6.2. Access to Ad. The user sees a billboard with a printed ad that is of interest. The user also sees a watermark in the printed ad that indicates that the ad has AR content. Alternatively, the App knows the users current location leveraging the Smartphone's GPS, and using a cloud service detects that an ad with AR content is in the proximity and brings this to the user's attention.
   6.3. AR Entity Scanning. The user then selects the System App and then navigate to the AR Entity Scanner, which provide a real-time video feed of the Smartphone's camera field of view. The user points the phone to the image of on the Billboard.
   6.4. AR Entity Candidate Detection. The app scans the vide feed looking for a print image to enter the field of view. It detects a candidate and begins to track the location of the image.
   6.5. Fingerprint Creation. The tracked image is extracted, and then normalized to compensate for tilt, rotation. Skewing and lighting creating a normalized image. This normalized image is then used to compute a recognition fingerprint using one of many possible perceptional hash algorithms.
   6.6. Recognition Service Call. The fingerprint, along with user metadata and scan-time metadata is assemble and submitted to a Recognition Call Service located in the Cloud.
   6.7. Recognition. The cloud service takes the fingerprint and used it as form of index to find and compare to fingerprints for previously established AR Entities. The recognition service will find all possible matches for the queried fingerprint, and calculates a goodness-of-fit metric for each match. If the best fitting fingerprint has a goodness-of-fit value greater than an established threshold, then a match is found. The Recognition Service returns a success packet back to the Smartphone application indicating a match has been found an preparing the app to receive the payload.
   6.8. Payload Selection. If a match is found, then the system then calls the Payload Selection Service. The payload selection service accesses payload selection rules stored for that AR Entity. In this example, the rules select on payload if the viewer is male, and another one if the user is female. Since our user is a male, the designated payload is selected.
   6.9. Payload Delivery. A call is now made to the Payload delivery service with a URL for the selected payload, as well as a database reference for that ad. The delivery service sends the Smartphone App data specifying the payload stream, cover image tracking data, and any Call-to-actions defined for that ad. At this point the cloud service begins steaming the payload data to the app.
   6.10. Application AR Projection. The app accepts the Streaming data, the cover image tracking and call-to-action data from the cloud service. It then takes the tracking data and uses that to lock onto and track the cover image seen in the camera-field-of-view. This tracking data allows better and more precise tracking of the cover image and provides the coordinated needed by the app to project the video payload onto the cover image using Augmented Reality techniques. The app then begins to buffer the steamed payload data. The buffered data is then sent to a rendering engine that creates a video playback window that is projected onto the coordinates of the tracked cover image. To the user, they see the cover image come to life as it is replaced by the video ad selected for the male viewer.
   6.11. Call-to-Action Display. As the Payload plays back, the App tracks the time of playback and at the specified time, the call-to-action, if defined, will display the specified graphic button at the position on the screen specified.
   6.12. Call-to-Action Follow Through. The app then begins to track screen clicks associated with the call-to-action button. If pressed, the app will vector the user to a Smartphone Browser that is now pointing to the web site specified in the call-to-action URL.
   6.13. User Action Reporting. The App then collects user viewing metadata and returns it to the Cloud Service. This tell the cloud service details around the payload playback: How much of the video was viewed, how many times it was viewed, and whether the call-to-action was engaged or not.
   6.14. Ad Analytics Update. At the completion of the recognition and playback cycle, the Cloud service will log all data necessary to update analytics around the ad, capturing critical data about this payload delivery.

An embodiment of the invention may be a machine-readable medium, including without limitation a non-transient machine-readable medium, having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a non-transient machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), erasable, programmable read-only memories (“EPROMs”), electrically-erasable read-only memories (“EEPROMs”), magnetic or optical cards, or any type of media suitable for storing computer instructions.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that delivery of different augmented-reality assets keyed to a single cover object and selected based on additional data sent by a user can also be accomplished by software and hardware that distribute the functions of embodiments of this invention differently than herein described. Such variations and implementations are understood to be captured according to the following claims.

I claim:

1. A method comprising:
imaging a scene containing a cover object using a digital camera having a live display;
identifying the cover object within the live display;
constructing an identifier associated with a user of the digital camera;
selecting an augmented data asset associated with both the identifier and the cover object from among a plurality of augmented data assets associated with the cover object; and
modifying the live display to include the augmented data asset near the cover object depicted on the live display.

2. The method of claim 1 wherein the augmented data asset is a video depicting the user of the digital camera.

3. The method of claim 1 wherein the augmented data asset is a first video advertisement for the cover object.

4. The method of claim 3, further comprising:
repeating the imaging, identifying and constructing operations;
selecting a second, different video advertisement from among the plurality of augmented data assets associated with the cover object; and
modifying the live display to include the second, different video advertisement near the cover object depicted on the live display.

5. A system comprising for delivering different augmented reality (“AR”) content to different users, comprising:
a cover object;
a recognizer for the cover object in digital images of scenes including the cover object; and
a database containing a plurality of AR assets corresponding to the cover object, wherein
the system receives a sample image of a scene including the cover object captured by a digital camera of a user and an auxiliary datum,
identifies the plurality of AR assets associated with the cover object in the database,
selects one of the plurality of AR assets according to the auxiliary datum, and
delivers the selected one of the plurality of AR assets to the digital camera of the user so that the digital camera will composite the selected one of the plurality of AR assets on a live display of the digital camera near the cover object shown on the live display.

6. The system of claim 5 wherein the sample image is a first sample image, the digital camera is a first digital camera and the auxiliary datum is a first auxiliary datum, and further wherein the system
receives a second sample image from a second digital camera of a similar scene including the cover object and a second auxiliary datum,
selects a different one of the plurality of AR assets according to the second auxiliary datum, and
delivers the different selected one of the plurality of AR assets to the second digital camera so that the second digital camera will composite the different selected one of the plurality of AR assets on a second live display of the second digital camera near the cover object shown on the second live display.

7. The system of claim 5 wherein the cover object is a tangible physical object.

8. The system of claim 7 wherein the cover object is a poster or a billboard.

9. The system of claim 7 wherein the cover object is a photograph.

10. The system of claim 7 wherein the cover object is a vehicle.

11. A tangible computer-readable medium containing data and instructions that, when executed by a programmable processor, cause a system including the programmable processor to perform operations comprising:
receiving a first digital image transmitted from a first digital camera of a first user at a first time;
receiving a second digital image transmitted from a second digital camera of a second user near the first time, wherein the first digital image and the second digital image depict a similar scene in which a cover object is present in both the first and the second images;
receiving, in connection with the first digital image, a first non-image selector;
receiving, in connection with the second digital image, a second non-image selector;
identifying the cover object in both the first and second digital images;
retrieving a plurality of augmented data objects associated with the cover object;
selecting a first augmented data object from the plurality of augmented data objects according to the first non-image selector;
selecting a second augmented data object from the plurality of augmented data objects according to the second non-image selector;
transmitting the first augmented data object to the first digital camera of the first user; and
transmitting the second augmented data object to the second digital camera of the second user.

12. The tangible computer-readable medium of claim 11, wherein the first digital image and the second digital image are first and second hash fingerprints prepared from the first digital image and the second digital image, respectively, said first and second hash fingerprints encoding significant features of the first and second digital images to permit identification of the cover object within the first and second digital images.

13. The tangible computer-readable medium of claim 11, containing additional data and instructions to cause the system including the programmable processor to perform further operations comprising:
updating a first live display of the first digital camera to include the first augmented data object, said first augmented data object composited near the cover object on the first live display; and
updating a second live display of the second digital camera to include the second augmented data object, said second augmented data object composited near the cover object on the second live display, wherein
the updating operations of the first live display and the second live display occur substantially simultaneously.

14. The tangible computer-readable medium of claim 11, containing additional data and instructions to cause the system including the programmable processor to perform further operations comprising:
receiving a third digital image transmitted from the first digital camera of the first user at a second, different time, said third digital image depicting a scene in which the cover object is present;
receiving, in connection with the third digital image, a third non-image selector;
identifying the cover object in the third digital image;
repeating the retrieving operation to retrieve the plurality of augmented data objects associated with the cover object;
selecting a third augmented data object, different from the first augmented data object, according to the third non-image selector;
transmitting the third augmented data object to the first digital camera of the first user; and
updating the first live display of the first digital camera to include the third augmented data object, said third augmented data object composited near the cover object on the first live display.

15. The tangible computer-readable medium of claim 11 wherein the cover object is a tangible object.

16. The tangible computer-readable medium of claim 15 wherein the cover object is a landmark.

17. The tangible computer-readable medium of claim 15 wherein the cover object is a magazine page.

18. The tangible computer-readable medium of claim 11 wherein the cover object is an intangible object.

19. The tangible computer-readable medium of claim 18 wherein the cover object is an illuminated pattern on a surface.

20. The tangible computer-readable medium of claim 11 wherein the cover object is a person who can be recognized by an automatic image recognizer.
